(19) United States
(12) Patent Application Publication
(10) Pub. No.: US 2014/0219693 A1
(43) Pub. Date: Aug. 7, 2014

(54) IMAGE FORMING APPARATUS

(71) Applicant: Satoru UCHIDA, Kanagawa (JP)

(72) Inventor: Satoru UCHIDA, Kanagawa (JP)

(21) Appl. No.: 14/100,539

(22) Filed: Dec. 9, 2013

(30) Foreign Application Priority Data
Feb. 1, 2013 (JP) 2013-018758

(51) Int. Cl. G03G 15/16

(52) U.S. Cl. CPC G03G 15/2028
USPC 399/316

(57) ABSTRACT

An image forming apparatus includes a sheet guide to guide a recording medium bearing an unfixed toner image with toner having a flow beginning temperature of equal to or less than 130° C. to a transfer nip between an image bearing member and a transfer roller. The sheet guide is disposed to satisfy the following relation: Y₁·θ₁≦θ₂≦Y₂·θ₁, where Y₁=0.5 and Y₂=3, and θ₁ is a central angle of a first arc corresponding to a width of the transfer nip on the image bearing member, and θ₂ is a central angle of a second arc of the outer circumference of the image bearing member with a beginning point of the second arc being a place at which the recording medium comes into contact with the image bearing member and an end point of the second arc being a start of the transfer nip.

### CROSS-REFERENCE TO RELATED APPLICATIONS

This patent application is based on and claims priority pursuant to 35 U.S.C. §119 to Japanese Patent Application No. 2013-018758, filed on Feb. 1, 2013, in the Japan Patent Office, the entire disclosure of which is hereby incorporated by reference herein.

### BACKGROUND

1. Technical Field

Exemplary aspects of the present invention generally relate to a fixing device and an image forming apparatus, such as a copier, a facsimile machine, a printer, or a multi-functional system including a combination thereof, and more particularly, to an image forming apparatus including the fixing device.

2. Description of the Related Art

There is growing market demand for fixation of toner at low temperature in recent years because it requires less energy to fix the toner and speeds up image formation while enhancing image quality in an image forming apparatus using an electrophotographic method.

Generally, with an increase in the speed of imaging process in such an electrophotographic image forming apparatus, image quality is degraded. There are several causes for such degradation of the quality of an image. Among known causes, a failure in fixing process leads to significant degradation of image quality.

In the fixing process, a fixing device applies heat and pressure to an unfixed toner image on a recording medium such as a sheet of paper, and the unfixed toner image is fixed to the recording medium. In this process, with an increase in a processing speed (system speed), the unfixed toner image is not heated properly, that is, not enough heat is obtained, resulting in a fixing failure. When this happens, the surface of the resulting toner image may get peeled off and a problem known as cold offset occurs, producing a poor quality image.

In one approach, when increasing the processing speed, a fixing temperature is increased in accordance with an increase in the processing speed in order to prevent degradation of image quality. However, a drawback of this approach is that heat from the fixing device affects adversely other imaging process and speeds up wear and tear of components employed in the fixing device. Furthermore, consumption of energy is increased. Thus, increasing the fixing temperature is not necessarily a good solution.

In a high-speed image forming apparatus, there is demand for enhancement of fixability of toner at low temperature. More specifically, in the fixing process, there is demand for reliable fixation of toner at low temperature. For example, JP-2002-351128-A proposes a toner with a flow beginning temperature of equal to or less than 130 degrees Celsius (° C.). However, the present inventor has recognized that the toner which can be fixed at such low temperature is difficult to transfer onto a recording medium.

In view of the above, there is thus unsolved need for an image forming apparatus capable of forming optimally an image using a toner fixed at low temperature.

### SUMMARY

In view of the foregoing, in an aspect of this disclosure, there is provided an improved image forming apparatus including an image bearing member, a developing device, a transfer device, a fixing device, and a sheet guide. The image bearing member bears a latent image on a surface thereof. The developing device develops the latent image formed on the image bearing member using toner having a flow beginning temperature of equal to or less than 130 degrees Celsius to form a toner image. The transfer device transfers the toner image onto a recording medium and includes a transfer roller and a bias voltage application device. The transfer roller is disposed opposite the image bearing member to form a transfer nip between a surface of the image bearing member and the transfer roller to transfer the toner image from the image bearing member onto a recording medium in the transfer nip. The bias voltage application device is operatively connected to the transfer roller to supply the transfer roller with a bias voltage to transfer the toner image from the image bearing member onto the recording medium. The fixing device fixes the toner image on the recording medium. The sheet guide is disposed upstream from the transfer roller in a direction of conveyance of the recording medium to guide the recording medium to the transfer nip. The sheet guide is disposed to satisfy the following relation:

Y₁·θ₁≦θ₂≦Y₂·θ₁, where Y₁=0.5 and Y₂=3, and θ₁ is a central angle of a first arc corresponding to a width of the transfer nip on an outer circumferential surface of the image bearing member forming the transfer nip with the transfer member, and θ₂ is a central angle of a second arc of the outer circumferential surface of the image bearing member and a beginning point of the second arc is a place at which the recording medium guided by the sheet guide comes into contact with the image bearing member and an end point of the second arc is a start of the transfer nip.

### BRIEF DESCRIPTION OF THE SEVERAL VIEWS OF THE DRAWINGS

A more complete appreciation of the disclosure and many of the attendant advantages thereof will be more readily obtained as the same becomes better understood by reference to the following detailed description of illustrative embodiments when considered in connection with the accompanying drawings, wherein:

FIGS. 1A and 1B are graphs, each showing a flow test curve;

FIG. 2 is a schematic diagram illustrating an image forming components employed in an image forming apparatus according to an illustrative embodiment of the present disclosure;

FIG. 3 is a schematic diagram illustrating a transfer device and surrounding components employed in the image forming apparatus;

FIG. 4 is a graph showing a relation of an angle θ₁ and an angle θ₂ according to Embodiment 1;

FIG. 5 is a schematic diagram illustrating another example of the image forming apparatus; and

FIG. 6 is a graph showing a relation of the angle θ₁ and the angle θ₂ according to Embodiment 2.

### DETAILED DESCRIPTION

A description is now given of illustrative embodiments of the present disclosure. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of this disclosure.

In addition, it should be noted that the terminology used herein is for the purpose of describing particular embodiments only and is not intended to be limiting of this disclosure. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

In describing illustrative embodiments illustrated in the drawings, specific terminology is employed for the sake of clarity. However, the disclosure of this patent specification is not intended to be limited to the specific terminology so selected, and it is to be understood that each specific element includes all technical equivalents that have the same function, operate in a similar manner, and achieve a similar result.

In a later-described comparative example, illustrative embodiment, and alternative example, for the sake of simplicity, the same reference numerals will be given to constituent elements such as parts and materials having the same functions, and redundant descriptions thereof omitted.

Typically, but not necessarily, paper is the medium from which is made a sheet on which an image is to be formed. It should be noted, however, that other printable media are available in sheet form, and accordingly their use here is included. Thus, solely for simplicity, although this Detailed Description section refers to paper, sheets thereof, paper feeder, etc., it should be understood that the sheets, etc., are not limited only to paper, but include other printable media as well.

Referring now to the drawings, wherein like reference numerals designate identical or corresponding parts throughout the several views, exemplary embodiments of the present patent disclosure are described.

An image forming apparatus according to an illustrative embodiment employs a toner with a flow beginning temperature of equal to or lower than 130° C. to form an image.

When using such a toner, an image may not be transferred properly to a recording medium such as a sheet of paper. With respect to such a transfer failure, the present inventor has recognized the following. The toner capable of low temperature fixation tends to degrade easily over time. Electrical charge of the degraded toner changes frequently, which complicates transfer of the toner image under a preset transfer setting. More specifically, when using such a degraded toner, an electric discharge occurs in a slight gap between a recording medium and a photosensitive member prior to transfer of a toner image, thereby charging the toner to an opposite charge. As a result, the toner image is not properly transferred onto the recording medium.

The amount of charge on toner changes when the toner is degraded over time. Thus, the toner is not properly transferred onto the recording medium under the preset transfer setting which has been set for the toner which is not degraded.

The present inventor has recognized that the degree of contact between the photosensitive member and the recording medium before the transfer process contributes to the prevention of charging the toner to the opposite charge.

According to an illustrative embodiment, the flow beginning temperature of the toner is measured using a flow tester under conditions with a testing load of 980 kPa (10 kg/cm²), a die orifice diameter of 0.50 mm, a die length of 10.0 mm, and a heating rate (speed) of 3° C. per minute. When the flow beginning temperature is too low, the hot offset decreases. By contrast, when the flow beginning temperature is too high, the fine particulate polymer in the surface layer inhibits, causing degradation of fixability.

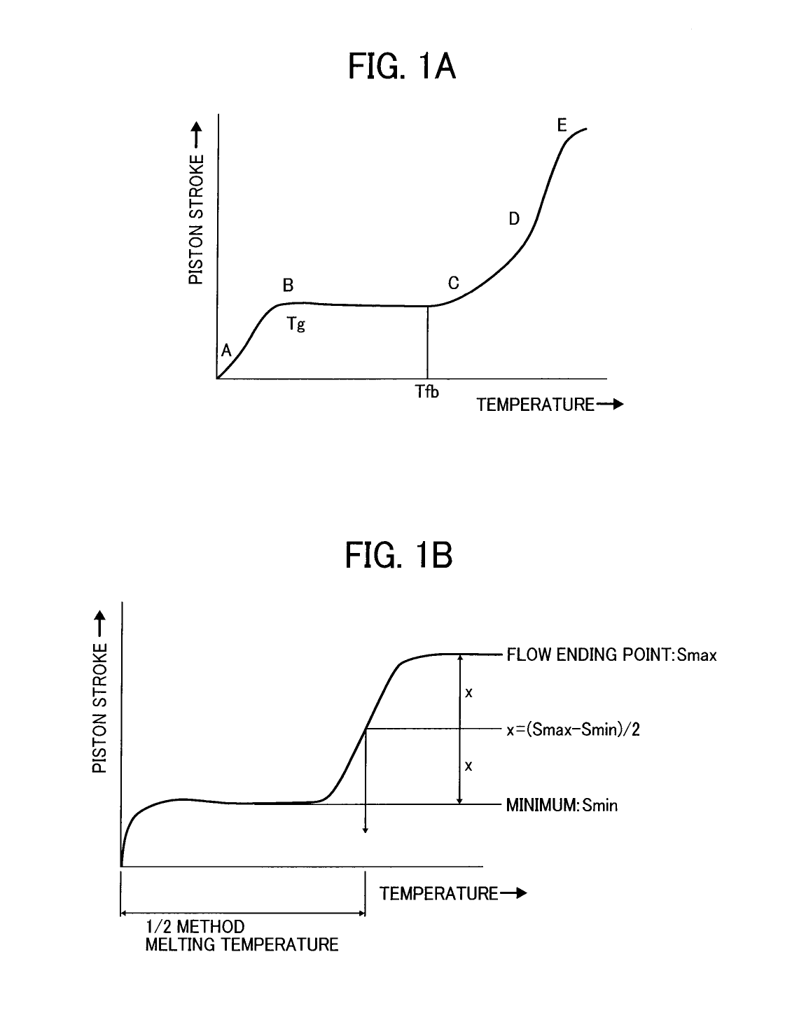

With reference to FIGS. 1A and 1B, a description is provided of a method of measuring the flow beginning temperature. The flow tester used here is, for example, a standalone-type flow tester CFT500C manufactured by Shimadzu Corporation. FIGS. 1A and 1B show flow curves measured by the flow tester.

As the temperature starts to rise, the piston stroke increases (“A” in FIG. 1A), and then the rise in the piston stroke stagnates (“B” in FIG. 1A). Subsequently, the piston stroke starts increasing again (“C” to “D” in FIG. 1A) and becomes constant after reaching a flow finish point as shown in FIG. 1B.

Various temperatures can be read out and obtained from the flow curves. In FIG. 1A, Tg represents a softening temperature, Tfb represents the flow beginning temperature, and “½-method temperature” refers to a melting temperature obtained by the ½ method. The melting temperature obtained by the ½ method is a T½ temperature.

Conventionally, various temperature parameters are used as parameters for thermal characteristics of a toner or a binder resin. However, due to increasing demand for the low-temperature fixing in recent years, the importance of the characteristics of the flow curves has been increasing.

The toner used in the image forming apparatus of the illustrative embodiment of the present disclosure is a toner having a flow beginning temperature of equal to or less than 130° C., which can accommodate the low-temperature fixing. The lowest threshold flow beginning temperature is equal to or higher than 80° C. at which the thermal storage resistance of the toner is optimized.

A known toner having a flow beginning temperature of equal to or less than 130° C. includes, for example, the toner mentioned in JP-2002-3511288-A.

Furthermore, the present inventor has developed another toner having a flow beginning temperature of equal to or less than 130° C.

That is, the toner including at least four kinds of binder resins has been developed by the present inventor. The toner contains at least a crystalline polyester resin A, a non-crystalline resin B, a non-crystalline resin C, and a complex resin D. The complex resin D contains a polycondensation-based resin unit and a polyaddition-based resin unit. The non-crystalline resin B contains a chloroform-insoluble component, and the non-crystalline resin C has a melting temperature 25° C. (T½)or lower than the non-crystalline resin B. The toner has a molecular weight distribution having a main peak between approximately 1,000 and 10,000 with a half value width of approximately 15,000 or less as measured by gel permeation chromatography (GPC) for the tetrahydrofuran (THF) soluble component of the toner.

The toner having a main peak between approximately 1,000 and 10,000 tends to degrade easily. By contrast, according to the illustrative embodiment of the present disclosure, an adequate transfer nip can be reliably maintained, thereby allowing good imaging regardless of the degraded toner and reducing power consumption.

Specific examples of the alcohol component of the crystalline polyester resin A include, but are not limited to, known components such as 1,4-butanediol, 1,5-pentanediol, and 1,6-hexanediol. Specific examples of the carboxylic acid component of the crystalline polyester resin A include, but are not limited to, fumaric acid, maleic acid, terephthalic acid, succinic acid, and trimellitic acid. The crystalline polyester resin A preferably has an ester bond represented by the following chemical formula I in the main chain.

[—OCO—R—COO—(CH₂)ₙ—] Chemical Formula I

In the chemical formula I, R denotes a residual group of linear unsaturated aliphatic dicarbocylic acid and n denotes an integer of from 2 to 20.

The toner including the crystalline polyester resin is easily degraded. However, according to the illustrative embodiment, an adequate transfer nip can be reliably maintained regardless of the degraded toner, hence allowing good imaging and reducing power consumption.

In addition, a specific example of the non-crystalline resin B or the non-crystalline resin C includes a polyester resin. Specific examples of the polycondensationable monomers of the complex resin D include, but are not limited to, a polyol alcohol and a polycarboxylic acid that form a polyester resin unit; a polycarboxylic acid and an amine that form a polyamide resin unit or a polyester-polyamide resin unit; and an amino acid. A specific example of the polyadditionable monomer includes a vinyl monomer.

The toner containing a crystalline polyester resin has a concern in terms of electrical characteristics. More specifically, the crystalline polyester resin has a relatively low electrical resistance (volume resistivity value) so that when the toner includes the crystalline polyester resin with a relatively large dispersion diameter, the electrical resistance of the toner tends to be low. As the electrical resistance of the toner decreases beyond its permissible range, a significant transfer failure occurs in the transfer process in image formation. More specifically, when suppressing compatibility of the crystalline polyester in order to maintain the low-temperature fixing ability, the dispersion diameter of the crystalline polyester remains relatively large.

As a result, the electrical characteristics of the crystalline polyester become dominant easily in the toner, causing the electrical resistance to drop easily. Furthermore, when the content of the carbon black as a colorant is large, the electrical resistance of the toner tends to decrease even more.

When using such a toner, for example, a toner having a common logarithm value log p of the volume resistivity p (Ω·cm) equal to or less than 10.5 (log[Ω·cm]), the following transfer failure may occur. More specifically, when the recording medium and the image bearing member do not contact tightly or the degree of contact between the recording medium and the image bearing member is not adequate, the toner is charged to a positive charge due to the electric discharge, hindering transfer of the toner image.

According to the illustrative embodiment, an adequate transfer nip can be reliably maintained, hence allowing good imaging and reducing power consumption.

Furthermore, because the adequate transfer nip is reliably obtained, a desired image quality can be obtained even when a bias application device for supplying a bias voltage to the recording medium always supplies a certain bias voltage. Thus, control of the bias voltage can be simplified while reducing the power consumption, hence reducing the cost of the image forming apparatus as a whole.

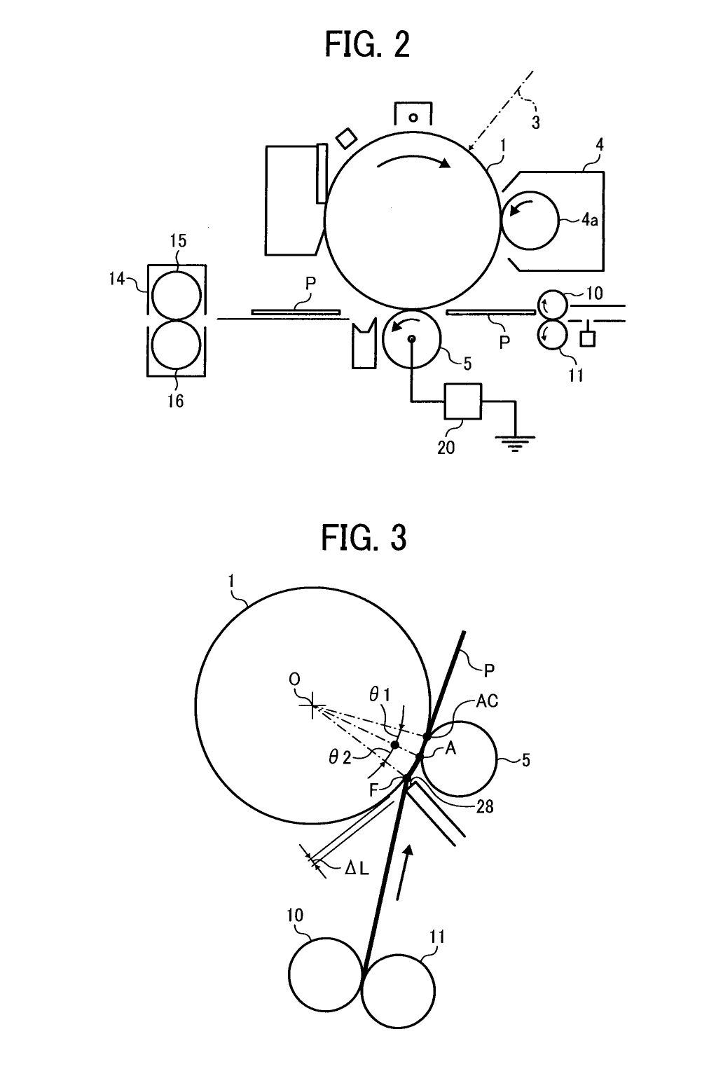

With reference to FIG. 2, a description is provided of the image forming apparatus according to an illustrative embodiment of the present disclosure. FIG. 2 illustrates main elements of forming an image according to an illustrative embodiment of the present disclosure.

The image forming apparatus includes a drum-shaped image bearing member (e.g., a photosensitive member) 1, a transfer device equipped with a transfer roller 5 and a transfer bias power source 20, a developing device 4, a fixing device 14, and so forth. In accordance with image data, laser light 3 illuminates (exposes) a photosensitive layer (which has been charged by a charger) of the image bearing member 1 rotating at a predetermined speed, thereby forming an electrostatic latent image on the surface thereof. The laser light 3 is deflected periodically by a polygon mirror rotating at a certain speed and scans repeatedly the photosensitive layer of the image bearing member 1 in a main scanning direction perpendicular to a sub-scanning direction, thereby exposing the photosensitive layer and forming an electrostatic latent image on the surface thereof. According to the present illustrative embodiment, a drum or a roller-type image bearing member is employed. Alternatively, a belt-type image bearing member entrained about rotary members may be employed. In this case, a transfer nip is formed between the belt surface entrained about the roller and the transfer roller.

Subsequently, an electrostatic latent image formed on the photosensitive layer of the image bearing member 1 is developed by the developing device 4. More specifically, a developing roller 4a of the developing device 4 supplies powder toner to the electrostatic latent image on the image bearing member 1.

Subsequently, the transfer bias power source (bias voltage application device) 20 of the transfer device supplies the transfer roller 5 (a transfer portion) with a transfer bias voltage having a polarity opposite that of the toner. The transfer bias power source 20 is operatively connected to the transfer roller 5.

In the meantime, a recording medium P is fed from a sheet feeding unit to conveyer rollers 10 and 11, and is delivered to the transfer nip between the transfer roller 5 and the image bearing member 1. With the transfer bias voltage supplied to the transfer roller 5 or the transfer portion, the toner image is transferred onto the recording medium P in the transfer nip.

Subsequently, the recording medium P is delivered to the fixing device 14 equipped with a fixing roller 15 and a pressing roller 16 which presses against the fixing roller 15, forming a fixing nip therebetween. The fixing nip is preheated at a proper temperature. The recording medium P bearing the toner image is fixed in the fixing nip at which pressure and heat are applied to the toner image on the recording medium P.

With reference to FIG. 3, a description is provided of transfer of the toner image. FIG. 3 is a schematic diagram illustrating the transfer roller 5 and the surrounding structure. The transfer device includes the transfer bias power source 20 (shown in FIG. 2) and the transfer roller 5 to supply the recording medium P with the bias voltage. The toner image formed with unfixed toner having the flow beginning temperature of equal to or less than 130° C. is formed on the surface of the image bearing member 1. The transfer device according to the present illustrative embodiment transfers the toner image onto the recording medium P in the transfer nip between the image bearing member 1 and the transfer roller 5.

According to the present illustrative embodiment, an angle θ₁ (it may also be referred to as “transfer nip amount”) is a central angle of an arc AC of the nip width of the transfer nip on an outer circumferential surface of the roller-type image bearing member 1 forming the transfer nip with the transfer roller 5. In other words, the central angle is an angle AOC with points A and C located on the outer circumference of the image bearing member 1 and vertex O located at the center of the roller-type image bearing member 1.

An angle θ₂ (it may also be referred to as “pre-transfer nip amount”) is a central angle of an arc AF of the outer circumferential surface of the image bearing member 1. That is, the central angle is an angle AOF with points A and F located on the outer circumference of the image bearing member 1, where F is a place at which the recording medium P guided by a sheet guide 28 comes into contact with the image bearing member 1 and A is a start of the transfer nip. The sheet guide 28 is disposed at a sheet supply side of the image bearing member 1 (i.e., upstream from the transfer nip in the direction of sheet conveyance). According to the present illustrative embodiment, the image forming apparatus satisfies the following relation between the angle θ₁ (transfer nip amount) and the angle θ₂ (pre-transfer nip amount):

Y1·θ₁≦θ₂<Y₂·θ₁,

where Y₁=0.5 and Y₂=3

Fluctuations in the degree of contact between the recording medium P and the image bearing member 1 may be adjusted by measuring a gap (AL in FIG. 3) between the sheet guide 28 and the image bearing member 1. However, the pre-transfer nip amount is an important characteristic value.

When the pre-transfer nip amount (the angle θ₂) is too large, the degree of contact of the recording medium relative to the image bearing member 1 fluctuates in the main scanning direction, resulting in a significant difference in the density of an image at the right and the left in the direction of sheet conveyance. Variations in flatness (accuracy of parts and parts placement) of the sheet guide 28 are assumed to be the cause. Preferably, the angle θ₂ is 0.8 times the angle θ₁ or greater, but less than or equal to 1.5 times the angle θ₁.

### Embodiment 1

The present inventor studied the relation between the angle θ₁ (transfer nip amount) and the angle θ₂ (pre-transfer nip amount) using a toner having a flow beginning temperature of 125° C. The toner was made in the following manner.

<Recipe of Toner>

Polyester resin A (monomer: adduct of bisphenol A with PO/EO, terephthalic acid/trimellitic acid, Tg of 62° C.): 60 parts by weight;

Polyester resin B (monomer: adduct of bisphenol A with PO/EO, terephthalic acid/trimellitic acid, Tg of 62° C.): 30 parts by weight;

Graft copolymer of polyethylene-styrene/acrylic (monomer: polyethylene, styrene, and methyl acrylate, Tg of 61° C.): 10 parts by weight;

Carnauba wax subjected to a treatment of eliminating free aliphatic acid therefrom (melting point: 83° C.): 5 parts by weight; and

Carbon black (#44, manufactured by Mitsubishi Chemical Co., Ltd.): 10 parts by weight.

<Manufacturing of Toner>

The above toner recipe was stirred and mixed in a HENSCHEL MIXER and thereafter kneaded by a twin-shaft extruder followed by cooling-down, pulverization, and classification to obtain mother toner. 0.5% by weight hydrophobic silica and 0.3% by weight titanium oxide were admixed with the thus-obtained mother toner to prepare toner as the final product.

<Relation between the Angle θ₁ and the Angle θ₂>

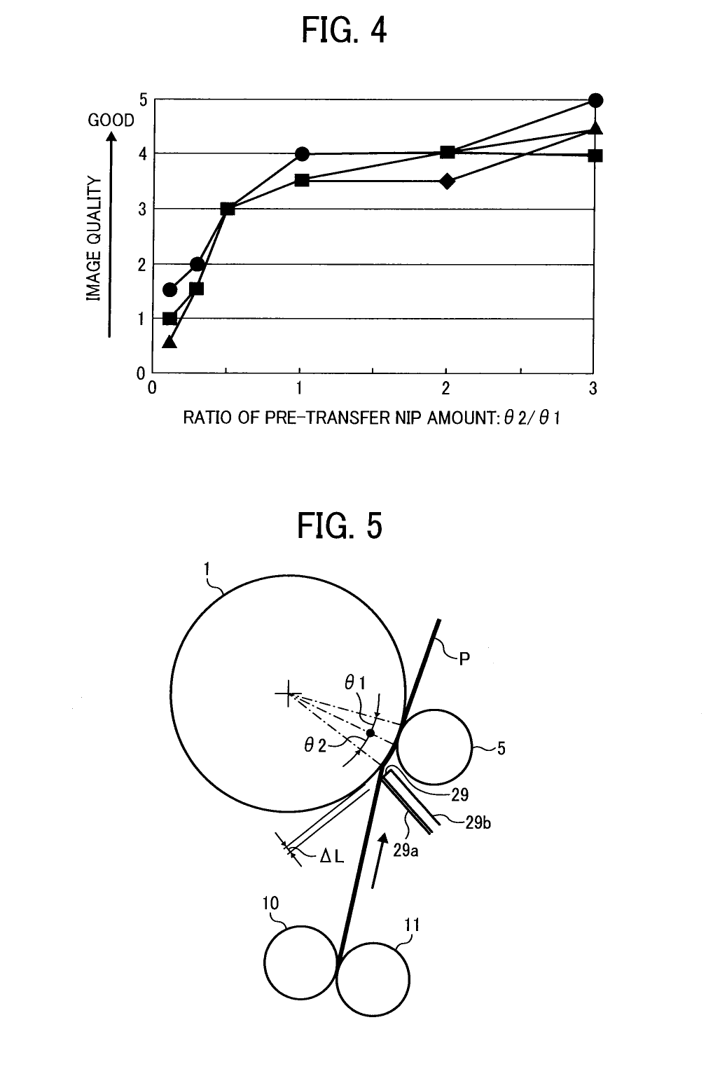

The thus-obtained toner was degraded using the image forming components shown in FIGS. 2 and 3. More specifically, the toner was put in the developing device, and a small image having a very small image area (close to a blank sheet, and a consumption of toner is very small) was output on 2000 sheets of A4-size recording media. The position of the sheet guide was changed to study the relation between the angle θ₁ (transfer nip amount) and the angle θ₂ (pre-transfer nip amount). The image quality was visually evaluated and was graded on a five point scale of 1 to 5, where 5 is the highest grade and 1 is the lowest grade. To be an acceptable image, the image quality needs to be graded as 3 and above. The test was repeated four times, and results are shown in FIG. 4.

As can be understood from FIG. 4, when satisfying the above-described equation, it is possible to form an image having an acceptable image quality.

### Embodiment 2

With reference to FIG. 5, a description is provided of another example of the image forming apparatus. FIG. 5 is a partially enlarged schematic diagram illustrating another example of the image forming apparatus.

According to the present illustrative embodiment, instead of using the sheet guide 28, a sheet guide 29 with a conductive sheet 29a and an insulating base member 29b is employed. The conductive sheet 29a is adhered to a surface of the base member 29b that comes into contact with the recording medium P. The conductive sheet 29a is formed of conductive material such as a conductive plastic sheet, thereby preventing toner from scattering and hence contaminating the leading end portion of the sheet guide 29. More specifically, the conductive sheet 29a is prevented from getting charged by friction with the recording medium. Furthermore, the scattered toner does not stick to the conductive sheet 29a and to the recording medium. Furthermore, according to the present illustrative embodiment, the conductive sheet 29a is in an electrically floating state, thereby preventing more reliably scattering of toner.

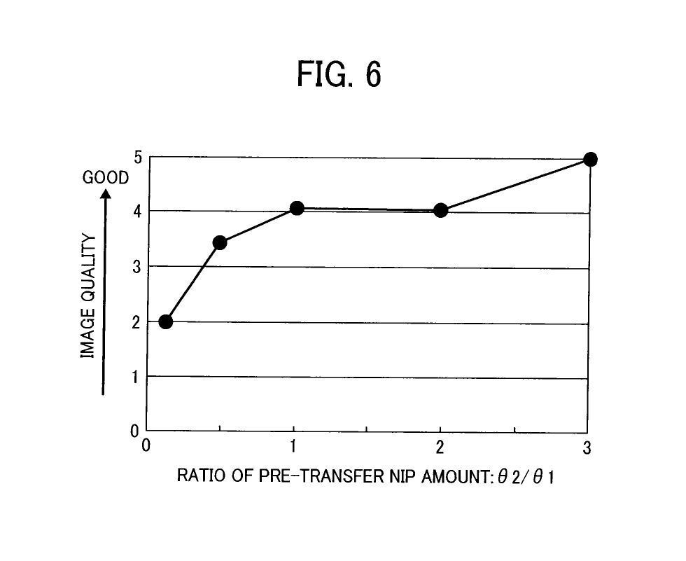

Similar to Embodiment 1, the relation between the angle θ₁ and the angle θ₂ was studied, and the results are shown in FIG. 6.

As can be understood from FIG. 6, even when the angle θ₂ (pre-transfer nip amount) is less than the angle that can obtain the same or similar results as in Embodiment 1, the acceptable image quality was obtained.

According to an aspect of this disclosure, the present invention is employed in the image forming apparatus. The image forming apparatus includes, but is not limited to, an electrophotographic image forming apparatus, a copier, a printer, a facsimile machine, and a digital multi-functional system.

Furthermore, it is to be understood that elements and/or features of different illustrative embodiments may be combined with each other and/or substituted for each other within the scope of this disclosure and appended claims. In addition, the number of constituent elements, locations, shapes and so forth of the constituent elements are not limited to any of the structure for performing the methodology illustrated in the drawings.

Example embodiments being thus described, it will be obvious that the same may be varied in many ways. Such exemplary variations are not to be regarded as a departure from the scope of the present invention, and all such modifications as would be obvious to one skilled in the art are intended to be included within the scope of the following claims.

What is claimed is:

1. An image forming apparatus, comprising:
an image bearing member to bear a latent image on a surface thereof;
a developing device to develop the latent image formed on the image bearing member using toner having a flow beginning temperature of equal to or less than 130 degrees Celsius to form a toner image;
a transfer device to transfer the toner image onto a recording medium, the transfer device including
a transfer roller disposed opposite the image bearing member, to form a transfer nip between a surface of the image bearing member and the transfer roller to transfer the toner image from the image bearing member onto a recording medium in the transfer nip, and
a bias voltage application device operatively connected to the transfer roller, to supply the transfer roller with a bias voltage to transfer the toner image onto the recording medium;
a fixing device to fix the toner image on the recording medium; and
a sheet guide to guide the recording medium to the transfer nip, the sheet guide being disposed upstream from the transfer roller in a direction of conveyance of the recording medium to satisfy a following relation:
Y₁·θ₁≦θ₂≦Y₂·θ₁, where Y₁=0.5 and Y₂=3, and θ₁ is a central angle of a first arc corresponding to a width of the transfer nip on an outer circumferential surface of the image bearing member forming the transfer nip, and θ₂ is a central angle of a second arc of the outer circumferential surface of the image bearing member with a beginning point of the second arc being a place at which the recording medium guided by the sheet guide comes into contact with the image bearing member and an end point of the second arc being a start of the transfer nip.

2. The image forming apparatus according to claim 1, wherein at least a portion of the sheet guide that contacts the recording medium is conductive.

3. The image forming apparatus according to claim 1, wherein the bias voltage application device supplies always the bias voltage at a constant level.

4. The image forming apparatus according to claim 1, wherein a flow beginning temperature of the toner is equal to or greater than 80 degrees Celsius.

5. The image forming apparatus according to claim 1, wherein the toner has a molecular weight distribution having a main peak between 1,000 and 10,000 as measured by gel permeation chromatography (GPC) for a tetrahydrofuran (THF) soluble component of the toner.

6. The image forming apparatus according to claim 1, wherein the toner includes at least a crystalline polyester resin.

7. The image forming apparatus according to claim 1, wherein a common logarithm value log p of a volume resistivity ρ (Ω·cm) of the toner is equal to or less than 10.5 (log [Ω·cm]).

8. The image forming apparatus according to claim 1, wherein the image bearing member is a roller.
